(19) United States
(12) Patent Application Publication
(10) Pub. No.: US 2012/0086955 A1
(43) Pub. Date: Apr. 12, 2012

(54) IMAGE PROCESSING APPARATUS WITH CALIBRATION FUNCTION AND METHOD OF CONTROLLING THE IMAGE PROCESSING APPARATUS

(75) Inventor: Jun Nagai, Tokyo (JP)

(73) Assignee: CANON KABUSHIKI KAISHA, Tokyo (JP)

(21) Appl. No.: 13/233,324

(22) Filed: Sep. 15, 2011

(30) Foreign Application Priority Data
Oct. 6, 2010 (JP) 2010-226540

(51) Int. Cl. G06K 15/02; G06F 3/12

(52) U.S. Cl. 358/1.2; 358/1.15

(57) ABSTRACT

A problem that multiple apparatuses execute their calibration all at the same timing occurs in a case where the apparatuses obtain the same environmental condition information from an environment sensor shared among the apparatuses. To solve this, an image processing apparatus: obtains environmental condition information from an environment detection device, the environment detection device sending detected environmental condition information to image processing apparatuses; holds a correction interval adjustment value for adjusting a calibration execution timing; and determines the calibration execution timing by using the held correction interval adjustment value, if it is judged based on the environmental condition information that calibration is necessary. The image processing apparatus then performs the calibration at the determined timing to correct the colors on output images.

### BACKGROUND OF THE INVENTION

1. Field of the Invention

The present invention relates to an image processing apparatus and a method of controlling an image processing apparatus. The present invention relates particularly to a method of controlling calibration in an image processing system in which multiple image processing apparatuses are connected to each other, the calibration stabilizing the colors on output images outputted from the multiple image processing apparatuses.

2. Description of the Related Art

It has heretofore been known that long term use of an image processing apparatus such as a printer or a copying machine may change its image output characteristics such as the densities and colors on output images.

For example, the image output characteristics gradually change as the number of printed outputs increases in continuous printing in some cases. Similarly, the image output characteristics change in some cases when there is a change in the condition of the environment (e.g., temperature, humidity, etc.) in which the image processing apparatus is installed.

In a case of an image processing apparatus that performs electrophotographic image formation, the electrophotographic process includes steps such as: laser exposure; formation of latent images on photosensitive bodies; development with toners; transfer of toner images onto an output medium such as a paper sheet; and fixation by heat. These steps in the process are likely to be affected by the temperature and humidity around the apparatus, deterioration of components over time, and the like, which in turn changes the amount of toners to be eventually fixed onto the output medium. As a result, the densities, colors and the like of on the output image are changed.

Some techniques regarding a calibration process for stabilizing the colors on output images have been proposed for solving defective output images attributable to a change in the image output characteristics as mentioned above. The following is an exemplary calibration process performed in an electrophotographic image processing apparatus.

First, in the apparatus, patch patterns at a predetermined density level obtained through a halftone process are formed at multiple points on an intermediate transfer body as toner images, and the densities of the patches are measured by a sensor provided in the apparatus. Thereafter, based on the measurement result, the density characteristics of the halftone process are calculated for input density levels to create a density correction table so that the input density levels of print data would be shifted to their corresponding standard density values. Then, this density correction table is used to correct the input density levels of print data. In this way, the densities and colors on output images can always be maintained within a certain range in accordance with the input density levels. The above-described calibration process is described in Japanese Patent Laid-Open No. 2000-238341, for example.

The above calibration process is often performed automatically in image processing apparatuses such as printers and copying machines. For example, calibration is automatically performed whenever there is a change equal to or above a predetermined value in an environmental condition such as temperature or humidity detected by a temperature sensor or a humidity sensor provided to the image processing apparatus. Such an action prevents the image output characteristics from being changed by a change in the environmental condition. In addition, some techniques have been known in which calibration is automatically performed whenever the number of continuously printed sheets reaches or exceeds a predetermined number.

Meanwhile, the calibration process has a technical problem that an output process cannot be performed during the execution of the calibration process. That is, if the calibration process is being executed when a user executes a printing process, the user must wait for a while to obtain the output because the calibration process takes a certain amount of time. Moreover, in a case where there exist multiple image processing apparatuses each of which performs a calibration process automatically, the timing to perform the calibration is usually determined individually for the apparatuses by using their own environmental conditions or predetermined numbers of printed outputs.

Now, assume an image processing system in which multiple image processing apparatuses are connected to each other. In this image processing system, the timings for the multiple image processing apparatuses to execute their calibration processes may possibly coincide with each other if no adjustment is made between the apparatuses for the timings to start the calibration processes. Such a coincidence lowers convenience provided to the user by the image processing apparatuses connected to each other through a network. Specifically, in an image processing system in which multiple image processing apparatuses are connected to each other, when an image processing apparatus is executing a calibration process or out of order, some other image processing apparatus can be used for alternative printing; however, if the timings to execute calibration processes coincide with each other, the alternative printing cannot be performed with that other image processing apparatus, thus lowering the convenience of the connection among the multiple apparatuses.

To address a problem as described above in an image processing system, techniques have been proposed in which a management server is installed in the system to control the calibration execution timings for image processing apparatuses connected to each other through a network to thereby prevent the convenience from being lowered (see Japanese Patent Laid-Open Nos. 2006-163052 and 2006-074394, for example). The technique in Japanese Patent Laid-Open No. 2006-163052 controls the calibration execution timings as follows. Upon receipt of a calibration request from an image processing apparatus on the network, the management server checks the calibration statuses of the apparatuses connected through the network and counts the number of apparatuses executing calibration. If the number of apparatuses executing calibration is not larger than a predetermined number, the management server permits the requested calibration. The technique in Japanese Patent Laid-Open No. 2006-074394 controls the calibration execution timings by causing the management server to schedule the execution of calibration processes. The management server is used as described above because the calibration execution timing for each individual image processing apparatus has no correlation with those for the other image processing apparatuses, and therefore it is difficult to adjust the calibration execution timings without the management server.

However, for image processing systems facing the trend of becoming less and less expensive, providing each apparatus with a control device such as a temperature sensor or a humidity sensor for use in a calibration process is a cause of a cost increase. This, in turn, gives a good prospect to an image processing system in which an environment sensor, such as a temperature sensor or a humidity sensor, provided to a certain external apparatus or used for some other purpose is shared by multiple image processing apparatuses and utilized for the control of the image processing apparatuses.

The sharing of an environment sensor has become easier to achieve especially because low-power wireless modules using short-range wireless standards such as ZigBee (registered trademark) have started to be put into practical use, making the environment sensor serve as one component of the network.

Now, assume that image processing apparatuses under such an environment are configured to automatically execute their calibration whenever there is a change equal to or above a predetermined value in the environmental condition. In this case, the multiple image processing apparatuses sharing the environment sensor execute their calibration all at the same timing. That is, obtaining the same environmental condition information from the shared environmental sensor leads to the coincidence of the calibration execution timings. This, as a result, lowers the convenience provided by the image processing apparatuses connected to each other via a network.

The possibility of the environmental condition information causing simultaneous execution of calibration is not so high in a conventional case where every image processing apparatus is equipped with its own environment sensor. This is because the timing to obtain the environmental condition information and/or the accuracy of the environment sensor may differ from one apparatus to another.

Both of the techniques in Japanese Patent Laid-Open Nos. 2006-163052 and 2006-074394 require a management server for controlling the timings in order to avoid simultaneous occurrence of calibration; however, calibration control using a management server requires complicated processes. Hence, it is difficult to implement these techniques in simple image processing systems facing the trend of becoming less and less expensive.

The present invention has been made in view of the above problems and provides an image processing system having multiple image processing apparatuses connected to each other and being capable of easily avoiding simultaneous occurrence of calibration processes.

### SUMMARY OF THE INVENTION

An image processing apparatus of the present invention comprises: an obtaining unit configured to obtain environmental condition information from an environment detection device, the environment detection device sending detected environmental condition information to image processing apparatuses; a holding unit configured to hold a correction interval adjustment value for adjusting a calibration execution timing; a judgment unit configured to judge whether calibration is necessary on the basis of the environmental condition information obtained by the obtaining unit; an adjustment unit configured to adjust the calibration execution timing by using the correction interval adjustment value held in the holding unit, if the judgment unit judges that calibration is necessary; and a calibration unit configured to perform the calibration at the timing determined by the determination unit and corrects the colors on images to be outputted.

According to the present invention, it is possible to perform such control that multiple image processing apparatuses can individually adjust their own calibration execution timings in a case where a calibration process is to be executed on the basis of information commonly used by the apparatuses. Thus, it is possible to provide an image processing apparatus, in an image processing system, which is capable of easily avoiding the occurrence of calibration processes at the same timing.

Further features of the present invention will become apparent from the following description of exemplary embodiments (with reference to the attached drawings).

### BRIEF DESCRIPTION OF THE DRAWINGS

FIG. 1 is a diagram showing an image processing system in which multiple image processing apparatuses are connected networks;

FIG. 2 is a diagram showing an example of the hardware configuration of a copying machine (image processing apparatus) in an embodiment of the present invention;

FIG. 3 is a block diagram showing a configuration required for data processing in the image processing system;

FIG. 4 is a block diagram showing a detailed example of the configuration of the image processing unit in the embodiment of the present invention;

FIG. 5 is a block diagram showing a detailed example of the configuration of a calibration processing unit in the embodiment of the present invention;

FIG. 6 is a flowchart showing a procedure in a process for creating a density correction table;

FIGS. 7A and 7B are diagrams showing an example of a density measurement process performed during a calibration process;

FIGS. 8A and 8B are explanatory diagrams for explaining the density correction table;

FIG. 9 is a diagram showing a flow of control on the execution timing of a calibration process in Embodiment 1;

FIGS. 10A and 10B are diagrams showing the concept of priorities and correction interval adjustment values; and

FIG. 11 is a diagram showing a flow of control on the execution timing of a calibration process in Embodiment 3.

### DESCRIPTION OF THE EMBODIMENTS

Hereinbelow, best modes for carrying out the present invention will be described by using the drawings.

### Embodiment 1

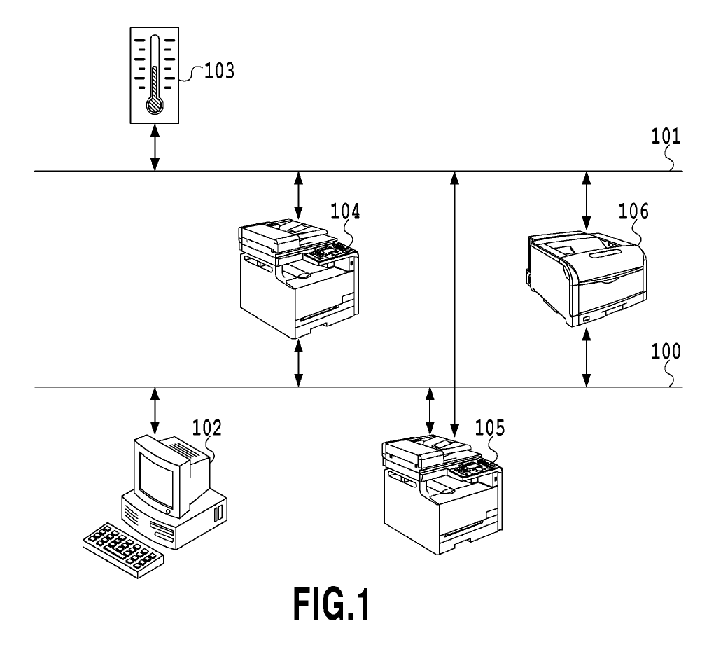

FIG. 1 is a diagram showing a system of an embodiment in which multiple image processing apparatuses such as a printer and copying machines are connected to networks.

The image processing system of this embodiment shown in FIG. 1 is constituted of a host computer 102, a copying machine A (104), a copying machine B (105), and a printer 106 all of which are connected to each other via a network 100. The connection is such that the host computer 102 can use any of the copying machine A (104), the copying machine B (105), and the printer 106. Note that both of the copying machines A and B have the same functions. The host computer 102 is capable of delivering print information used for performing a printing process, such as color information, letter/character, diagram, image, and the number of copies, to the copying machine A (104), the copying machine B (105), and the printer 106. There is also an environment sensor 103 which is an environment detection device capable of sending environmental condition information such as temperature or humidity to the copying machine A (104), the copying machine B (105), and the printer 106 via a network 101. In this embodiment, an image processing apparatus refers to any of the copying machine A (104), the copying machine B (105), and the printer 106. Note that the environmental condition information refers to information indicating a temperature, humidity, or the like in the environment where the environment sensor 103 is installed. Moreover, the environmental condition information may be information indicating not only the temperature or humidity but also a difference thereof from the last sent environmental condition information.

Meanwhile, the environment sensor 103 does not necessarily have to be a sensor used exclusively for controlling the copying machine A (104), the copying machine B (105), and the printer 106. In other words, the environment sensor 103 may detect environmental condition information and send it to apparatuses of other types than copying machines and printers for the purpose of controlling these other apparatuses. The environment sensor 103 only needs to be able to detect temperature or humidity and send it to apparatuses around the environment sensor 103.

Here, a system generally called Ethernet (registered trademark) can be used as the network 100. With this system, information exchange and data transfer are performed between units connected to each other through protocols such as TCP/IP by means of a physical cable such as a 10Base-T cable. Note that the communication building the network 100 is not limited to a wired one using a network cable, and a wireless technique may be used to build the same system. In addition, a system called ZigBee (registered trademark) may be used as a short-range wireless communication for the network 101. ZigBee (registered trademark) is a communication standard conforming to IEEE802.15.4, and is low in power consumption and thus considered suitable for constructing a sensor network. The network 101 does not necessarily have to be constructed by ZigBee (registered trademark) as a matter of course, and may be constructed by a different wireless communication system. It is also possible to construct the network 101 by use of a wired network. Moreover, the same system can be constructed by connecting the environment sensor 103 not to the network 101 but directly to the network 100 via a control device. That is, while this embodiment will be described by taking an example using two different networks, this embodiment can be applied to a case of using a single network.

Note that to share the environment sensor means to perform control in such a way that the output result from the environment sensor will be valid only to the image processing apparatuses situated in the environmental which the environment sensor detects a condition from. If all the image processing apparatuses connected to the network 100 are to receive the environmental condition information from the environment sensor, image processing apparatuses situated in different installation environments are controlled in accordance with the output result of the environment sensor. To solve this, this embodiment employs a ZigBee (registered trademark) sensor network to assume that only the image processing apparatuses in the same environment as the environment sensor can recognize the output result therefrom (i.e., environmental condition information). This utilizes the fact that a ZigBee (registered trademark) network has an effective communication range of approximately 40 m, making it impossible to control devices located in very different environments. Meanwhile, in a case of planning a wired network, the environment in which the image processing apparatuses are installed may be associated with the network addresses thereof. Then, the environmental condition information may be sent by multicast transmission or the like to the image processing apparatuses identified to be in the same environment.

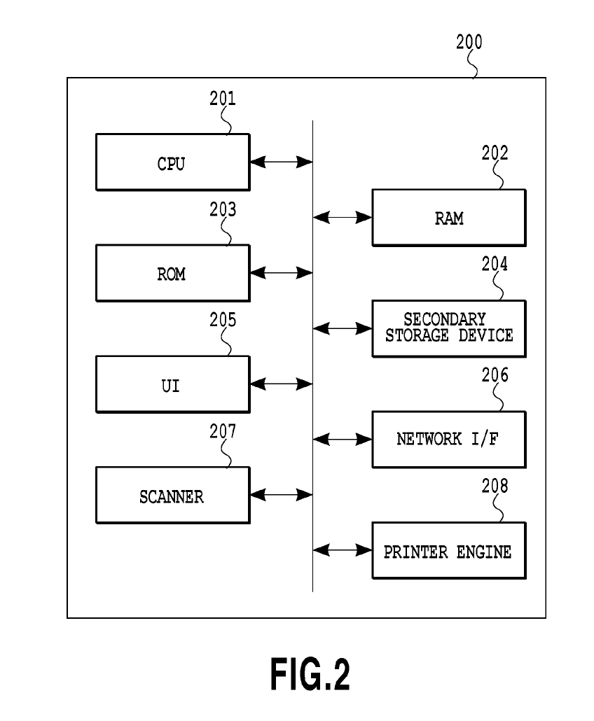

FIG. 2 is a diagram showing an example of the hardware configuration of a copying machine 200 in this embodiment. The copying machine 200 includes: a CPU 201 that executes various processes; a ROM 203 that stores therein programs and tables for implementing various flowcharts to be described later; and a RAM 202 that provides a temporary storage area. The copying machine 200 also includes: a secondary storage device 204 such as a hard disk or a flash memory; and a user interface (hereinafter, UI) 205 that includes buttons and a display device such as a liquid crystal display. The copying machine 200 also includes a network interface (hereinafter, network I/F) 206, through which the copying machine 200 receives print information from the host computer and environmental condition information from the environment sensor. The copying machine 200 also includes: a scanner 207 as a document reader; and a printer engine 208.

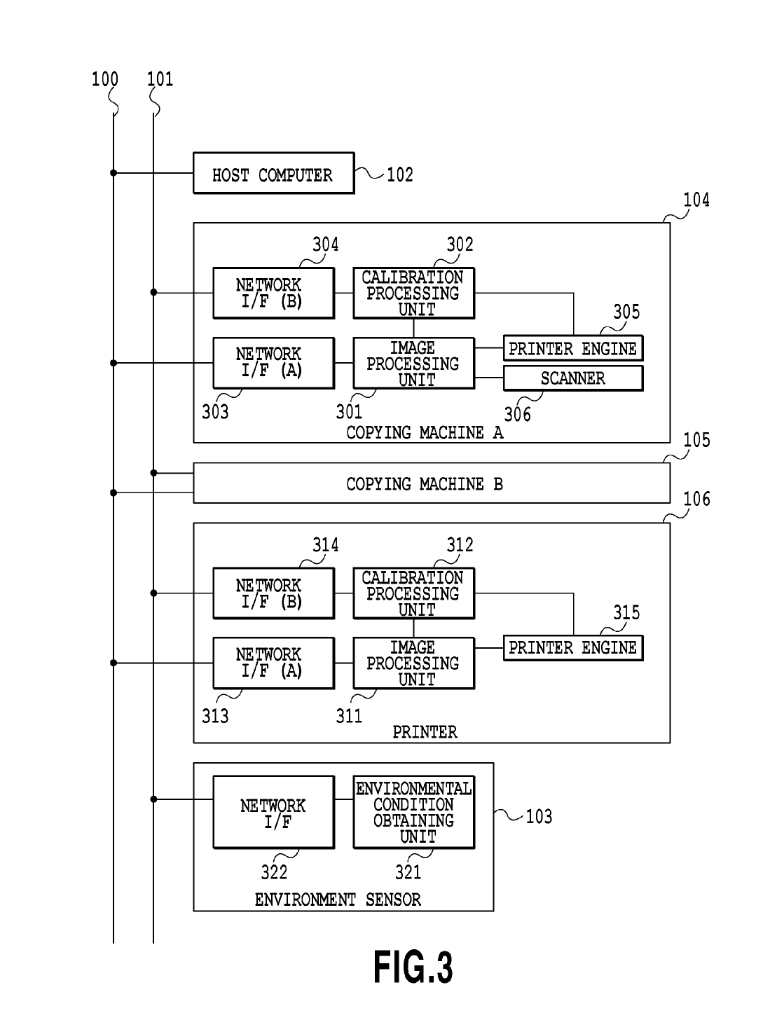

FIG. 3 is a block diagram showing a configuration required for data processing in the image processing system shown in FIG. 1.

The copying machine A (104) includes an image processing unit 301 and a calibration processing unit 302 which are connected to each other via a bus. The image and calibration processing units 301 and 302 are connected to the networks 100 and 101 via network I/Fs A (303) and B (304), respectively. In addition, a scanner 306 and a printer engine 305 are connected to the image processing unit 301. The scanner 306 reads a document to obtain image signals. The printer engine 305 performs actual image formation on the basis of the image signals delivered from the image processing unit 301.

Print information from the host computer 102 is obtained by the network I/F A (303) via the network 100 and processed by the image processing unit 301. On the other hand, environmental condition information from the environment sensor 103 is obtained by the network I/F B (304) via the network 101. The calibration processing unit 302 adjusts a calibration execution timing on the basis of the obtained environmental condition information.

Note that the copying machine B (105) in FIG. 3 has the same functions as the copying machine A (104) as mentioned previously. The printer 106 also has the same functions as the copying machine A (104), except that no scanner is connected to its image processing unit 311.

The environment sensor 103 has an environmental condition obtaining unit 321 which obtains information indicating environmental condition such as temperature or humidity as environmental condition information. The obtained environmental condition information is sent from a network I/F 322 to each of the copying machine A (104), the copying machine B (105), and the printer 106 through the network 101. Note that the timing to send the environmental condition information may be such that the environmental condition information is sent every time there is a change equal to a preset value in the temperature or humidity or that the real-time environmental condition information is sent at a given interval. The sending timing is set in advance by the user. The environment sensor 103 notifies the image processing apparatuses of the same environmental condition information all at once.

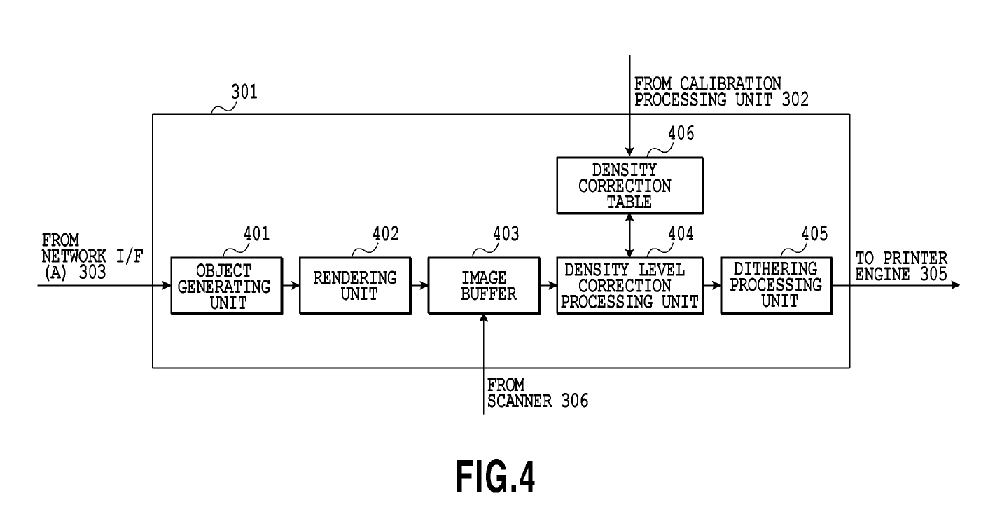

FIG. 4 is a block diagram showing a detailed example of the configuration of the image processing unit 301 included in each of the copying machines A (104) and B (105).

Referring to FIG. 4, an object generating unit 401 converts print information such as letter/character, diagram, image, and/or the like (page description language) inputted from the host computer 102 via the network I/F A (303), into intermediate information (hereinafter, referred to as “object”).

A rendering unit 402 performs a rendering process based on one page of the converted object to convert the object into a bitmap image as a drawing target. An image buffer 403 stores therein the bitmap image generated by the rendering unit 402. Incidentally, each of the copying machines A (104) and B (105) also stores in the image buffer 403 a bitmap image obtained by reading a document by means of the scanner 306.

A density level correction processing unit 404 uses a density correction table 406 created by the calibration processing unit 302 to correct density levels of the bitmap image stored in the image buffer 403. The process performed by the density level correction processing unit 404 will be described later. A dithering processing unit 405 performs a digital halftoning process on the bitmap image whose density levels have been corrected so that the density levels would match the output gradations of the printer engine 305. The data of the bitmap image generated by the digital halftoning process is sent to the printer engine 305 and subjected to an electrophotographic image process there. As a result, toners are fixed onto an output medium, completing the printing process.

Note that the image processing unit 311 of the printer 106 has the basically same configuration as the image processing unit 301 of each copying machine. That is, the printer 106 performs the same printing process and density level correction process on print information from the host computer 102, except the process on a bitmap image obtained by the scanner 306.

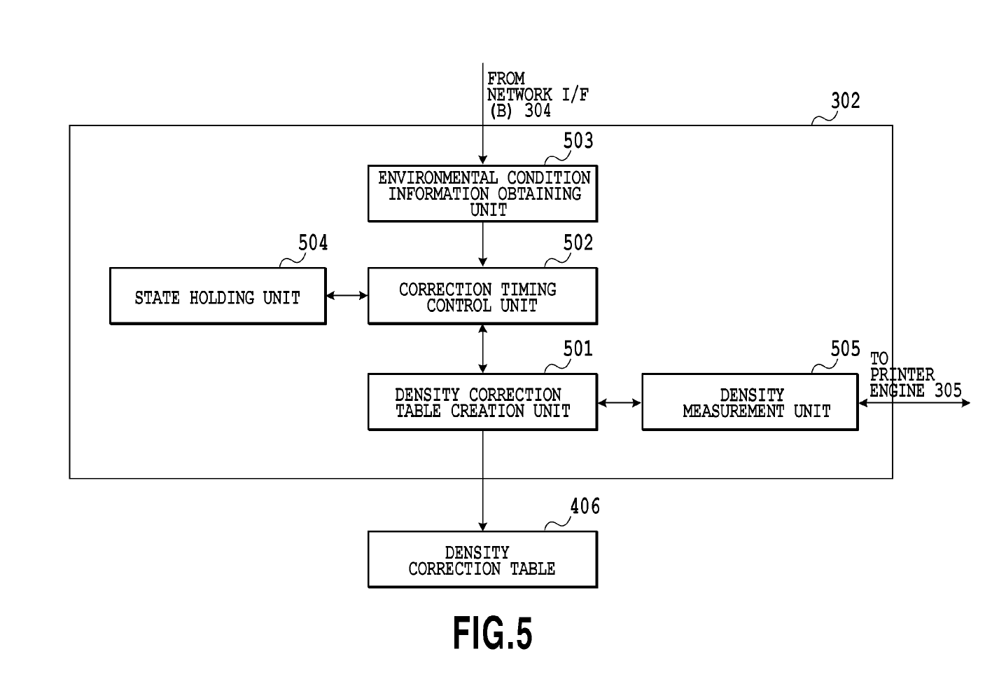

FIG. 5 is a block diagram showing a detailed example of the configuration of the calibration processing unit 302.

A correction timing control unit 502 controls the execution timing of a calibration process on the basis of state information on the image processing apparatus (copying machine A (104) and B (105)) held in a state holding unit 504 and environmental condition information obtained by an environmental condition information obtaining unit 503. The state information is information that is specific to the apparatus and related to the execution of a calibration process, and refers for example to the number of outputs printed since the execution of the last calibration process, the time elapsed since the execution of the last calibration process, or the like. The state holding unit 504 holds this state information. The state holding unit 504 also holds a correction interval adjustment value that is utilized when a calibration process is executed by using environmental condition information. The correction interval adjustment value refers to an adjustment value that is used to adjust the execution timing of a calibration process and is specific to the corresponding image processing apparatus. The setting of the correction interval adjustment value will be described later. Meanwhile, the environmental condition information obtaining unit 503 obtains environmental condition information from the environment sensor 103 via the network I/F B (304). The environmental condition information here indicates temperature, humidity, or the like as mentioned previously.

A density correction table creation unit 501 allows a patch pattern to be formed on an intermediate transfer body in a case where the correction timing control unit 502 determines the execution of a calibration process. Thereafter, a density measurement unit 505 measures the density values of the patch pattern by using a sensor provided to the printer engine to create or update the density correction table 406. The calibration process then ends.

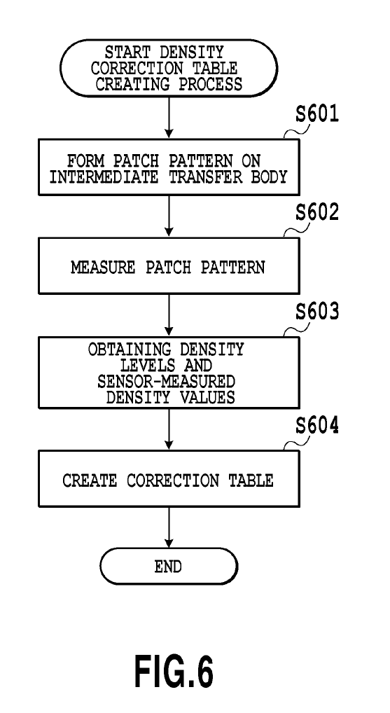

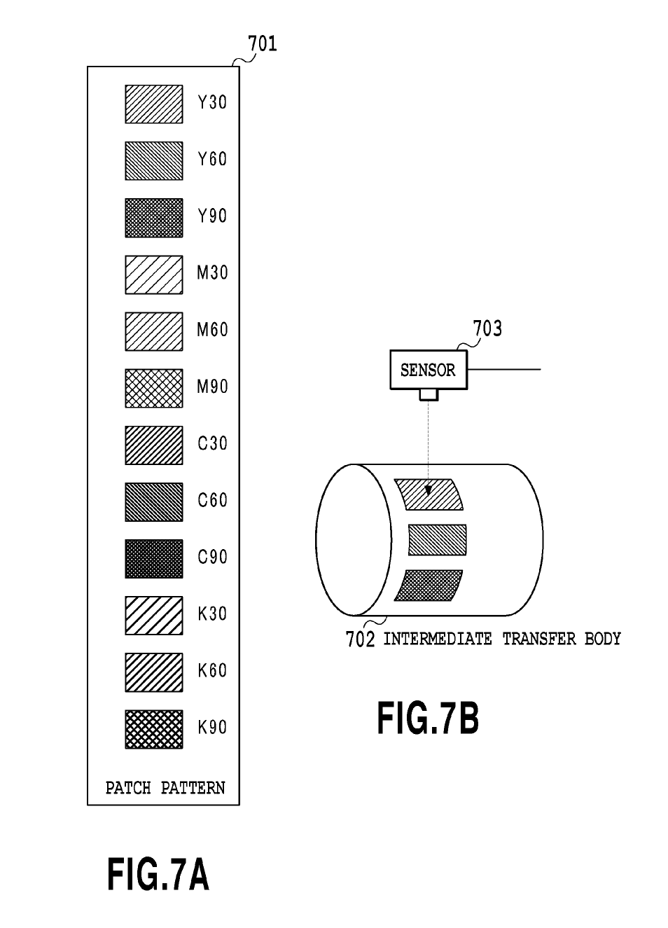

FIG. 6 is a diagram showing a procedure in a process for creating the density correction table 406 during a calibration process. The following process shown in the flowchart is implemented by causing the CPU 201 to execute a program stored in the ROM 203 and temporarily loaded to the RAM 202. In addition, FIGS. 7A and 7B are diagrams showing how the density measurement unit 505 performs the density measurement process during a calibration process. In the following, description will be given of process operations of the density correction table creation unit 501 of each image processing apparatus of this embodiment by using these diagrams.

Reference sign 701 in FIG. 7A shows an exemplary patch pattern having colors of Y, M, C, and K at given halftone density levels selected from a density-level range of 0 to 255. This patch pattern 701 is actually printed on an intermediate transfer body 702 in FIG. 7B, and the density measurement unit 505 uses a sensor 703 to measure the densities of the printed patch pattern 701. In the explanatory example of FIG. 7A, the patch pattern 701 has density levels of 30H, 60H, and 90H (H denotes a hexadecimal number) for each of Y, M, C, and K.

The density correction table is created by first forming the patch pattern 701 on the intermediate transfer body 702 (step 5601) and then measuring the densities of the patch pattern 701 by the sensor 703 (step S602).

Thereafter, the density correction table creation unit 501 obtains the density-level values of the formed patch pattern 701 and the sensor-measured density values measured in step S602 (step S603). Using the obtained sensor-measured density values at the density levels, the density correction table creation unit 501 creates a density correction table by which density characteristics corresponding to the input density levels can be converted into standard density characteristics (step S604). The process then ends.

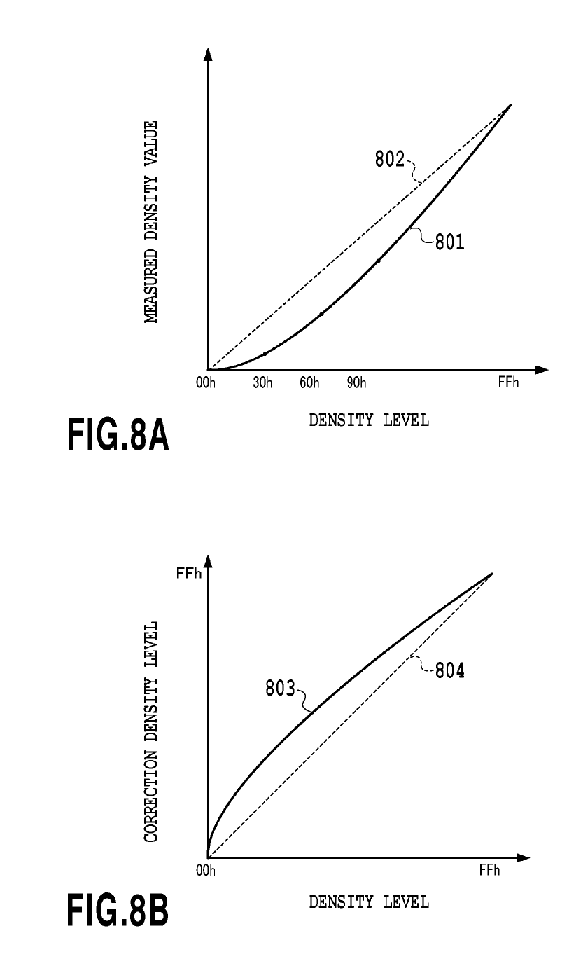

FIGS. 8A and 8B are explanatory diagrams for explaining the aforementioned density correction table.

A solid line 801 in FIG. 8A represents density characteristics corresponding to input density levels found based on measurement values obtained by printing the density correction patch pattern 701 and measuring it with the sensor 703 as described from step S601 to S603 in FIG. 6. A broken line 802 in FIG. 8A represents example predetermined standard density characteristics in which the input density levels and the density characteristics have a linear correlation. A solid line 803 in FIG. 8B represents a density correction table actually created. Using this density correction table allows the density characteristics represented by the solid line 801 in FIG. 8A to be corrected into standard density characteristics represented by a broken line 804 in FIG. 8B. The process shown in FIG. 6 is described as a process to create a density correction table. However, if a density correction table is already set, a process to update the density correction table may be performed instead. The process flow shown in FIG. 6 is also applicable to the process to update the density correction table.

Next, description will be given of a process to control the execution timing of a calibration process which is performed by the correction timing control unit 502.

In this embodiment, each image processing apparatus automatically and individually judges the execution timing of its own calibration process. The condition to judge the execution timing includes the following two points. First is a condition based on the apparatus-specific information (state information) held in the state holding unit 504 such as the number of outputs printed or the time elapsed since the execution of the last calibration process. For instance, calibration is executed at a timing when the number of printed outputs changes to reach or exceed a preset value as a result of printing outputs after the execution of the last calibration. This execution timing of calibration correction based on the apparatus-specific information (state information) will be referred to as apparatus correction timing.

Second is a condition based on information that is shared among multiple apparatuses such as the environmental condition information which the environmental condition information obtaining unit 503 obtains from the environment sensor. In other words, this information shared among multiple apparatuses may be described as information commonly used by multiple apparatuses. In a conventional case where each apparatus is provided with its own environment sensor, environmental condition information maybe considered also as apparatus-specific information. On the other hand, since one environment sensor is shared among multiple image processing apparatuses in this embodiment, environmental condition information is information shared among the multiple image processing apparatuses. Note that an execution timing of calibration correction based on such information shared among multiple apparatuses (i.e., environmental condition information) will be referred to as external correction timing.

The correction timing control unit 502 obtains the state information, or the apparatus-specific information (state information obtaining process). Then, the correction timing control unit 502 judges that it is an apparatus correction timing and that correction is necessary, on the basis of the obtained state information, i.e., in a case where a given time has elapsed or a given number of outputs have been printed since the last calibration process. Moreover, the correction timing control unit 502 judges that it is an external correction timing and that correction is necessary, in a case where the environmental condition information shared among the multiple apparatuses indicates a change equal to or above a predetermined value. In sum, the correction timing control unit 502 judges that correction is necessary, in a situation based on an apparatus correction timing and a situation based on an external correction timing, respectively.

Note that using an external correction timing, which is based on the information shared among the multiple apparatuses, as a condition (trigger) to execute a calibration process will results in simultaneous occurrence of calibration processes in the multiple apparatuses.

In this embodiment, however, the timings to execute the calibration processes are shifted from one another on the basis of unique correction interval adjustment values that are set in advance to the apparatuses, in a case where the calibration processes are to be executed on the basis of the shared information. This avoids simultaneous occurrence of the calibration processes in the multiple image processing apparatuses sharing the information of the environment sensor with each other.

The timing adjustment using the correction interval adjustment values may be for instance a process in which the correction timings are adjusted by using the correction interval adjustment values so that calibration processes would not occur simultaneously in the apparatuses. In one example, the process may be such that apparatus correction timings for the apparatuses are adjusted by using the correction interval adjustment values.

Here, the correction interval adjustment values are values determined respectively for the apparatuses, and are desirably values different from one apparatus to another. Thus, a hash function for example may be used to generate random numbers so that mutually different correction interval adjustment values can be set to the apparatuses. To set correction interval adjustment values by using a hash function, the MAC addresses of the network I/Fs 206 may be used as hash keys. Note that simple generation of random numbers may require calibration to wait for a long time until being executed, departing from the idea of performing the calibration to handle a change in the environment. To solve this, the maximum allowable time is set for the time from the requesting of correction at an external correction timing until the execution of calibration. In this way, the random numbers can be determined to be appropriate correction interval adjustment values. For example, the setting may be such that the execution of calibration can wait up to 15 minutes after an external correction timing. In this case, the correction interval adjustment values are set to be random numerical values falling within a range from 0 to 15 minutes.

Alternatively, the correction interval adjustment values may be set based on the frequencies of use or functions of the apparatuses. For example, a small correction interval adjustment value may be set for a frequently used apparatus because such an apparatus is assumed to be used soon. Moreover, the correction interval adjustment values may be set based on the distances from the environment sensor to the apparatuses. For example, a large correction interval adjustment value may be set for an apparatus far from the environment sensor so as to prevent the apparatus to react sensitively to the environment sensor. Each of these settings can be determined as appropriate by the user via the UI 205.

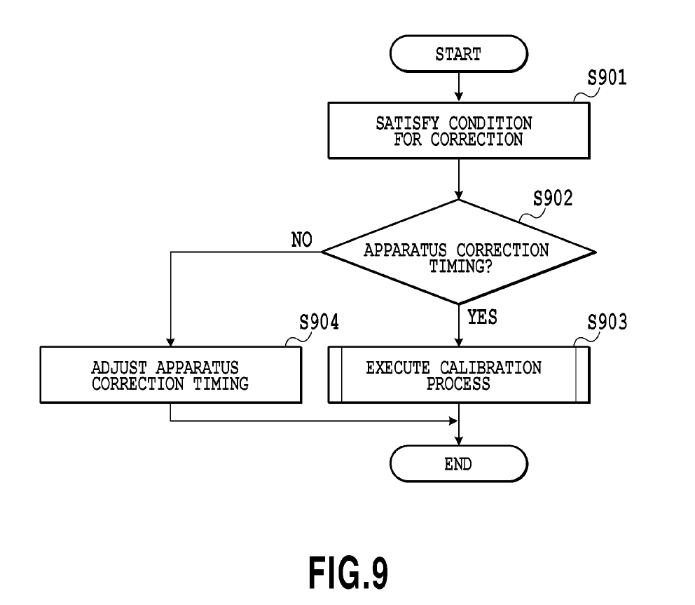

FIG. 9 is a diagram showing a flow of control on the execution timing of a calibration process in this embodiment, which is performed by the correction timing control unit 502. The following process shown in the flowchart is implemented by causing the CPU 201 to execute a program stored in the ROM 203 and temporarily loaded to the RAM 202.

First, a condition for correction is satisfied (S901). Then, the correction timing control unit 502 judges whether the correction request is made at an apparatus correction timing or at an external correction timing (S902). The correction timing control unit 502 performs a calibration process if judging that the correction request is made at an apparatus correction timing (Yes in S902), i.e., if the elapsed time or the number of printed outputs held in the state holding unit 504 satisfies the condition to execute a calibration process (S903). By performing the calibration process, the density correction table is updated. On the other hand, the correction timing control unit 502 performs the following process if judging that the correction request is made not at an apparatus correction timing but at an external correction timing (No in S902). Specifically, the correction timing control unit 502 proceeds to 5904, in which the correction timing control unit 502 adjusts a correction timing that is based on the state information held in the apparatus (i.e., apparatus correction timing). This adjustment is made based on a correction interval adjustment value of the corresponding apparatus held in the state holding unit 504. For example, if the correction interval adjustment value is equal to 5 minutes, the correction timing control unit 502 adjusts the information in the state holding unit 504 such that the correction will occur at an apparatus correction timing which is 5 minutes after the correction condition is satisfied at the external correction timing. After 5 minutes, it is determined that it is the apparatus correction timing and the correction condition is satisfied, whereby a calibration process is executed and the density correction table is updated accordingly. The control is performed in such a way that the correction occurs at the apparatus correction timing because the same calibration process will be executed regardless of whether the correction is based on an external correction timing or on an apparatus correction timing. To be specific, consider a case where correction is controlled by using only an external correction timing having subjected to the correction interval adjustment without considering an apparatus correction timing. In this case, there is a possibility that a calibration process is performed at the external correction timing and then at the apparatus correction timing continuously. Since the calibration is performed immediately before at the external correction timing, the apparatus correction timing has to count the number of outputs printed or the time elapsed after that time point. To solve this, control is so performed that the correction occurs at the apparatus correction timing. This brings about an advantage that wasteful, continuous calibration processes do not need to be performed. Note that in the adjustment of the information in the state holding unit 504, the correction timing control unit 502 adds an instruction to perform the calibration after 5 minutes for example, and in addition to this, the correction timing control unit 502 clears the elapsed time or the number of printed outputs held in the state holding unit 504 when the calibration is executed as instructed.

Meanwhile, it is possible that a correction request is made at an external correction timing immediately after the execution of calibration based on an apparatus correction timing. This case may be handled for example by making no adjustment on the apparatus correction timing until a certain time passes after the execution of the calibration process, even when a correction request is made at the external correction timing. This is because the calibration based on the apparatus correction timing may already have made the apparatus cope with the change in the environment. Accordingly, it is possible to avoid an unnecessary calibration process and thus to improve the convenience.

On the other hand, the information held in the state holding unit is cleared immediately after the execution of a calibration process based on an external correction timing. Therefore, a correction request will not be made at an apparatus correction timing immediately after the execution of the calibration process.

By a calibration process executed as described above, a density correction table is created, and this density correction table is used to perform a density-level correction process, whereby variations in the ranges and densities of colors on output images can be avoided.

Normally, in a case where information shared among multiple image processing apparatuses determines whether to execute a calibration process, the apparatuses sharing the information will make requests for their calibration processes simultaneously. This embodiment, however, utilizes this sharing of the same information in a positive way. That is, each apparatus shifts its execution timing by a corresponding, previously-determined interval from the point at which the correction requests are simultaneously made. Accordingly, simultaneous execution of calibration processes in the multiple image processing apparatuses are avoided.

As described above, according to this embodiment, a process to adjust the calibration execution timings of multiple apparatuses is performed in a case where calibration is to be executed based on information commonly used by the apparatuses such as environmental condition information obtained by a shared environment sensor. This process makes it possible to provide an image processing system that can easily avoid a decrease in the number of image processing apparatuses therein available to the user, which would otherwise occur due to simultaneous execution of calibration in the image processing apparatuses in the system.

### Embodiment 2

Embodiment 1 has been described by taking an example where, in a case of executing calibration on the basis of environmental condition information obtained by a shared environment sensor, each of multiple image processing apparatuses adjusts its execution timing by a corresponding, previously-determined interval from the point at which the correction requests are simultaneously made, to thereby avoid simultaneous implementation of calibration processes in the image processing apparatuses.

However, when the correction intervals set for the individual apparatuses are random numbers, it is possible that a timing assigned to an apparatus requiring sooner execution of calibration may be shifted to be later. Also, in some cases, the user has to do a troublesome work when he or she sets the correction intervals. It is especially not easy to set appropriate correction intervals every time the number of apparatuses increases or decreases.

In this embodiment, priorities are assigned in accordance with the pieces of apparatus-specific information held in the state holding units of the apparatuses, respectively. When executing calibration on the basis of the environmental condition information obtained by the shared environment sensor, the apparatuses adjust their own execution timings by using correction interval adjustment values corresponding to the priorities. This avoids the multiple apparatuses simultaneously executing their calibration processes.

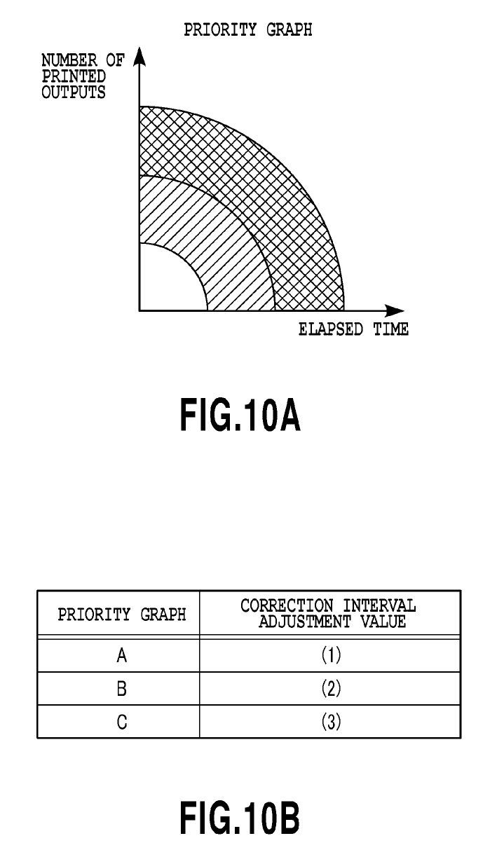

The system configuration in this embodiment is the same as that in Embodiment 1, and therefore detailed description thereof will be omitted. While the correction interval adjustment values in Embodiment 1 are previously determined values, the correction interval adjustment values in this embodiment are values determined on the basis of priorities of correction that are set on the basis of the pieces of apparatus-specific information held in the state holding units 504. FIGS. 10A and 10B show the concept of the priorities and the correction interval adjustment values.

Each state holding unit 504 holds, as the state information, the time elapsed and the number of outputs printed since the execution of the last calibration, and a priority is assigned to the state information as shown in FIG. 10A. Specifically, the multiple apparatuses are each classed as: one with a shorter elapsed time or a smaller number of printed outputs after the execution of the last calibration; or one with a longer elapsed time or a larger number of printed outputs after the execution of the last calibration. In FIG. 10B, the former apparatus is assigned a priority A, the latter apparatus is assigned a priority C, and an apparatus in between is assigned a priority B. The timing to class the apparatuses is when it is judged at an external correction timing that correction is necessary. Here, the priorities of correction are such that A is the highest and C is the lowest and that a higher priority allows calibration to be executed preferentially. Apparatuses falling within an area with orthogonal lines, an area with diagonal lines, and a blank area in FIG. 10A are assigned the priorities A, B, and C, respectively. After determining the priorities at an external correction timing, the correction interval adjustment values are determined uniquely as shown in FIG. 10B. Information in the table shown in FIG. 10B is held in advance in the state holding unit 504. In FIG. 10B, (1) represents the shortest correction interval and (3) represents the longest correction interval. This means that an apparatus with a higher priority is allowed to execute calibration with a smaller interval after making a correction request at an external correction timing. The processes subsequent to the determining of the correction interval adjustment values are the same as those in Embodiment 1. Note that in this example, the priority is divided into but not limited to three levels. The priority may be divided into finer levels.

As described above, according to this embodiment, priorities are assigned respectively to multiple apparatuses in accordance with their states, and correction interval adjustment values are set in accordance with the priorities, in a case where calibration is to be executed based on information commonly used by the apparatuses such as environmental condition information obtained by a shared environment sensor. Then, the calibration execution timings of the apparatuses are adjusted by using the correction interval adjustment values. This process makes it possible to provide an image processing system that can eliminate the need for the user to adjust the correction intervals and easily avoid a decrease in the number of image processing apparatuses therein available to the user, which would otherwise occur due to simultaneous execution of calibration in the image processing apparatuses in the system. Accordingly, it is possible to provide an image processing system that can avoid a decrease in the number of image processing apparatuses therein available to the user. Moreover, the priority may be divided into finer levels to prevent simultaneous execution of calibration in multiple apparatuses.

### Embodiment 3

Embodiment 2 has been described by taking an example where simultaneous execution of calibration is avoided by: assigning apparatuses with priorities in accordance with their states; setting correction interval adjustment values in accordance with the priorities; and adjusting the calibration execution timings for the apparatuses by use of the correction interval adjustment values.

There is, however, a possibility that some of the multiple apparatuses maybe assigned the same level of priority depending on their states, in which case their correction interval adjustment values may be set to be equal to each other.

In this embodiment, in a case of executing calibration on the basis of the environmental condition information obtained by the shared environment sensor, the apparatuses exchange the pieces of apparatus-specific information held in their state holding units with each other. Then, each apparatus determines its priority by comparing its own apparatus-specific information with the received apparatus-specific information of each of the other apparatuses to thereby adjust the correction interval. This avoids the multiple apparatuses simultaneously executing their calibration processes.

The system configuration in this embodiment is the same as that in Embodiment 1, and therefore detailed description thereof will be omitted. Moreover, the concept of the priorities in this embodiment is the same as that in Embodiment 2; the priority is higher for an apparatus with a shorter elapsed time or a larger number of printed outputs after the execution of the last calibration. However, the order of priority is determined not by classing the apparatuses as in Embodiment 2 but by comparing the information between the multiple apparatuses. In this embodiment, the calibration processing units 302 of the image processing apparatuses exchanges the pieces of information held in the state holding units 504 with each other via the network I/Fs (B) 304 to compare the priorities.

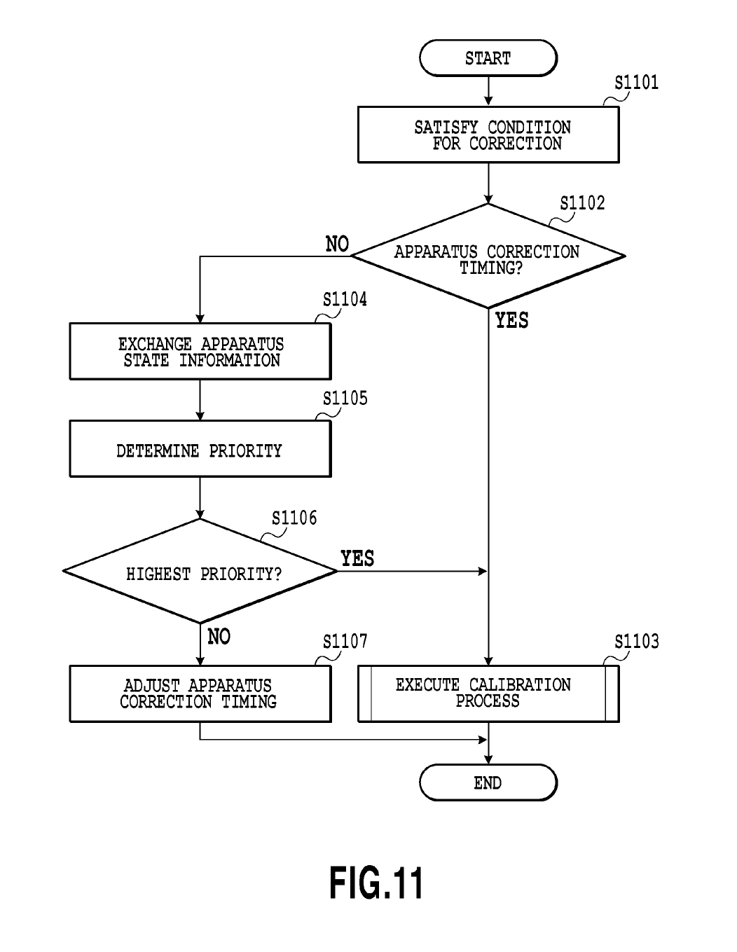

FIG. 11 is a diagram showing a flow of control on the execution timing of a calibration process in this embodiment, which is performed by the correction timing control unit 502. The following process shown in the flowchart is implemented by causing the CPU 201 to execute a program stored in the ROM 203 and temporarily loaded to the RAM 202.

First, a condition for correction is satisfied (S1101). Then, the correction timing control unit 502 judges whether the correction request is made at an apparatus correction timing or at an external correction timing (S1102). Like Embodiment 1, the correction timing control unit 502 performs a calibration process if judging that the correction request is made at an apparatus correction timing (Yes in S1102), i.e., if the elapsed time or the number of printed outputs held in the state holding unit 504 satisfies the condition to execute a calibration process (S1103). Consequently, the density correction table is updated.

On the other hand, if judging that the correction request is made not at an apparatus correction timing but at an external correction timing (No in S1102), the correction timing control unit 502 exchanges the apparatus-specific state information held in the state holding unit 504 with the other image processing apparatuses via the network I/Fs (S1104). Thereafter, the correction timing control unit 502 compares the state information of its apparatus with the state information received from each of the other image processing apparatuses to determine the priority (S1105). Specifically, the correction timing control unit 502 compares a value such as the elapsed time or the number of printed outputs as mentioned above. Then, if the priority based on the state information held in the apparatus is higher than those of the other image processing apparatuses (judging Yes in S1106), the correction timing control unit 502 performs a calibration process (S1103). Note that S1103 and S903 are the same process. Hence, the same process as Example 1 will be performed in a case where there is duplication between an apparatus correction timing and an external correction timing as described in Embodiment 1. If, on the other hand, the priority is lower than those of the other image processing apparatuses (judging No in S1106), the correction timing control unit 502 adjusts the apparatus correction timing in accordance with a correction interval adjustment value determined in accordance with the priority (S1107).

In Embodiment 3, in a case where multiple image processing apparatuses exist in an image processing system, each apparatus counts the number of apparatuses in the system that have higher priorities than the priority of the apparatus at the time of comparing the priorities (in S1106). This number is denoted as S. Then, a correction interval adjustment reference value is provided that is common within the entire image processing system. In this way, the correction interval adjustment value of each apparatus can be determined as “correction interval adjustment value=correction interval adjustment reference value×S”. Meanwhile, the correction interval adjustment reference value may be determined in advance on the basis of a time required to complete calibration for one apparatus.

As described above, according to this embodiment, correction interval adjustment values are set by comparing the states of multiple apparatuses with each other and assigning priorities on the basis thereof, in a case where calibration is to be executed based on information commonly used by the apparatuses such as environmental condition information obtained by a shared environment sensor. The calibration execution timings for the apparatuses are adjusted by using the correction interval adjustment values set as described above. This process makes it possible to eliminate the need for the user to adjust the correction intervals and to easily execute calibration simultaneously in the image processing apparatuses in the system. Accordingly, it is possible to provide an image processing system that can avoid a decrease in the number of image processing apparatuses therein available to the user. In addition, since the priorities are assigned on the basis of the comparison between the pieces of state information of the apparatuses, it is possible to prevent simultaneous execution of calibration in the apparatuses in the system at an external correction timing.

Each of the aforementioned embodiments has been described by taking an example where the environment sensor 103 is installed independently of each image processing apparatus. However, if for example an image processing apparatus equipped with an environment sensor is connected to the image processing system, information obtained by the environment sensor provided to the image processing apparatus may be sent to the other image processing apparatuses.

### Other Embodiments

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-226540, filed Oct. 6, 2010, which is hereby incorporated by reference herein in its entirety.

What is claimed is:

1. An image processing apparatus comprising:
an obtaining unit configured to obtain environmental condition information from an environment detection device, the environment detection device sending detected environmental condition information to image processing apparatuses;
a holding unit configured to hold a correction interval adjustment value for adjusting a calibration execution timing;
a judgment unit configured to judge whether calibration is necessary on the basis of the environmental condition information obtained by the obtaining unit;
a determination unit configured to determine the calibration execution timing by using the correction interval adjustment value held in the holding unit, if the judgment unit judges that calibration is necessary; and
a calibration unit configured to perform the calibration at the timing determined by the determination unit.

2. The image processing apparatus according to claim 1, wherein the calibration unit corrects a density of an output image.

3. The image processing apparatus according to claim 1, wherein the correction interval adjustment value held in the holding unit is determined by using information on at least one of a frequency of use of the image processing apparatus and a distance from the environment detection device.

4. The image processing apparatus according to claim 3, wherein the correction interval adjustment value is set to be smaller when the frequency of use of the image processing apparatus is higher.

5. The image processing apparatus according to claim 3, wherein the correction interval adjustment value is set to be larger when the distance from the environment detection sensor is longer.

6. The image processing apparatus according to claim 1, wherein the determination unit uses a random number to generate a value different from those generated by the other image processing apparatuses, and uses the value as the correction interval adjustment value.

7. The image processing apparatus according to claim 1, wherein the determination unit uses any value set by a user as the correction interval adjustment value.

8. The image processing apparatus according to claim 1, further comprising a state information obtaining unit configured to obtain state information indicating a state that is specific to the apparatus and related to execution of calibration, wherein
the determination unit
assigns a priority determined on the basis of the state information,
sets the correction interval adjustment value such that the correction interval adjustment value is smaller when the priority assigned to the apparatus is higher, and
allows calibration to be executed with a correspondingly smaller interval when the judgment unit judges that the calibration is necessary.

9. The image processing apparatus according to claim 8, wherein the priority is set to be higher when the number of printed outputs since execution of the last calibration is larger.

10. The image processing apparatus according to claim 8, wherein the priority is set to be higher when a time elapsed since execution of the last calibration is longer.

11. The image processing apparatus according to claim 1, further comprising a state information obtaining unit configured to obtain state information indicating a state that is specific to the apparatus and related to execution of calibration, wherein
the determination unit uses, as the correction interval adjustment value, a priority determined by comparing the state information with state information of each of the other image processing apparatuses.

12. The image processing apparatus according to claim 11, wherein the priority is set to be higher when the number of printed outputs is larger.

13. The image processing apparatus according to claim 11, wherein the priority is set to be higher when a time elapsed since execution of the last calibration is longer.

14. A method of controlling an image processing apparatus comprising:
an obtaining step of obtaining environmental condition information from an environment detection device, the environment detection device sending detected environmental condition information to image processing apparatuses;
a storing step of storing a correction interval adjustment value for adjusting a calibration execution timing;
a judgment step of judging whether calibration is necessary on the basis of the environmental condition information obtained in the obtaining step;
a determination step of determining the calibration execution timing by using the correction interval adjustment value stored in the storing step, if it is judged in the judgment step that calibration is necessary; and
a calibration step of performing the calibration at the timing determined in the determination step.

15. A program causing a computer to execute the method of controlling an image processing apparatus according to claim 14.
